(19) United States
(12) Patent Application Publication
(10) Pub. No.: US 2007/0252406 A1
(43) Pub. Date: Nov. 1, 2007

(54) Car cover and deployment system therefor

(76) Inventor: Stephen E. Webber, Beachwood, OH (US)

Correspondence Address: James A. Hudak, Esq.;Suite # 304, 29425 Chagrin Blvd., Cleveland, OH, 44122, US

(21) Appl. No.: 11/821,483

(22) Filed: Jun. 25, 2007

Related U.S. Application Data
(63) Continuation-in-part of application No. 11/384,529, filed on Mar. 20, 2006, now abandoned.

(51) Int. Cl. B60J 11/00

(52) U.S. Cl. 296/136.12; 296/136.1

(57) ABSTRACT

A protective flexible car cover that is attachable to and detachable from a foldable deployment rod, which facilitates deploying and removing the car cover from a vehicle, is disclosed. The attachment of the car cover to the deployment rod is effected by fasteners. The car cover has magnets or weights around its periphery to help hold the cover in place while being deployed and after deployment. Additional panels on the underside of the car cover and at the rear of the car cover are provided which can be held in place by the side doors of the vehicle or by the trunk lid.

### TECHNICAL FIELD

The present invention relates, in general, to car covers and, more particularly, to car covers that can be readily deployed and removed from a vehicle.

### BACKGROUND OF THE INVENTION

There are many different car covers presently available and even more have been the subject of prior patents. Most such covers are made from a flexible cloth material. The reasons to use a car cover include at least the following: 1) to diminish heating the interior of the vehicle when parked in the sun with the concomitant discomfort to passengers; 2) to protect the exterior of the vehicle against sun exposure, bird droppings, sap from trees, chemicals, such as oil contained in the runoff encountered in some garage facilities, blowing sand and/or salt encountered near the seashore, etc.; 3) to protect the interior of the vehicle against sun exposure and heating; 4) to protect the exterior of a car against impact, such as encountered in hail storms or accidental minor collisions during transportation. Car covers can be various sizes, depending on the intended use. For example, to minimize solar heating and sun/heat damage to the vehicle interior it is only necessary to cover the window spaces to obtain the desired effect. The benefits of a car cover are documented by the Dupont Corporation with respect to its materials Tyvek® or Tyvek® Plus. If all exterior surfaces of the vehicle are to be protected, the car cover should fit around the entire vehicle. In general, covering a car with a flexible material resistant to sun and other damaging elements of nature is not convenient, nor is the storage of the cover when not in use. The cover must be held onto the vehicle firmly to resist the effects of wind, or to minimize the potential for theft of the cover, which often leads to a multiple tie-down design that is also inconvenient and time-consuming. These factors tend to discourage users from buying car covers or even using a car cover unless it is anticipated that the vehicle will be out of use for an extended period of time. Thus, there is a need for a simple car cover system that makes the deployment and removal of the cover quick and convenient and one that can be stored quickly and compactly when not in use, such that the owner would be willing to use the assembly for relatively short periods of time. It is preferable not to make any permanent installations on the vehicle exterior or truck storage area to accomplish these objectives.

There are many designs for car covers that do not necessarily have any provision for improved ease of deployment. For example, there are a number of car covers designed to protect a vehicle against impact, using an energy-absorbing material, such as that disclosed in U.S. Pat. No. 6,220,648 (Daniel), U.S. Pat. No. 5,800,006 (Pettigrew), U.S. Pat. No. 5,664,825 (Henke, et. al.), U.S. Pat. No. 5,401,074 (Timerman), and U.S. Pat. No. 5,242,206 (Heck). These covers are relatively difficult to deploy and no provision is made for deployment of the car cover in these patents.

There are a number of patented designs in which a roller device is mounted in the trunk area of a vehicle for the purpose of holding a car cover. U.S. Pat. No. 5,855,406 (Vargo) teaches a spring-biased rollup system for a car cover that is stored in the car trunk for a car cover. A similar spring-biased roller system is taught in U.S. Pat. No. 5,597,196 (Gibbs) and in U.S. Pat. No. 5,456,515 (Dang). This device is fixed within the vehicle trunk area, which will interfere with normal storage in the trunk as well as require being fixed to the interior walls of the trunk. In U.S. Pat. No. 4,324,427 (Huang, et. al.) a car bumper is modified to hold a spring-activated roller on which a car cover is mounted. In addition to the mechanical complexity of this device, a permanent fixture must be added to the automobile. In U.S. Pat. No. 5,176,421 (Fasiska), an electrically driven roller system is taught, in conjunction with the use of a hand crank or a spring-actuated system. In this case a containment tube for the cover is mounted in the vehicle trunk. U.S. Pat. No. 4,958,881 (Piros) teaches a motor, spring or manually operated roller system that mounts to the underside of the vehicle trunk lid. A similar device is taught in U.S. Pat. No. 4,657,298 (O). In U.S. Pat. No. 4,834,446 (Tung-Chow), a mechanically cranked or electric motor actuated device that remains in the vehicle trunk winds a belt to which the car cover is attached. While requiring less volume than a trunk-mounted roller, the system is mechanically complex and does not aid the user in spreading the car cover evenly over the surface of the vehicle. U.S. Pat. No. 4,718,711 (Rabbit) teaches a double roller-bar system, one end of which is attached to the interior of the trunk and which requires both roller bars to reside on the vehicle exterior when the car cover is being deployed. While the use of a roller bar is expected to aid in the deployment of the car cover, in order for this approach to be useful, the bar must be at least the width of the vehicle making it less convenient for storage. In U.S. Pat. No. 5,597,197 (Mowar, et. al.), there is no mechanical deployment aid but a cross-member attached to the front of the car cover is supposed to aid in the deployment of the cover. This cross-member is not designed to deploy the cover by a simple rolling action but instead requires the user to support the weight of the cover plus the cross-member. Depending on the weight of the car cover material this is likely to be awkward to carry out.

There are a number of designs for a car cover alone, with no provision for improving the ease of deployment. For example, U.S. Pat. No. 5,409,286 (Huang) teaches the use of a form-fitting cover with an elastic band on the periphery of the cover to hold the cover more tightly to the passenger compartment of the vehicle. In U.S. Pat. No. 5,188,417 (Curchod), a similar system is described except that explicit provision is made for a storage pouch that is mounted in the trunk. U.S. Pat. No. 4,842,324 (Carden) teaches a four-sided cab cover in which a better fit to the contour of the vehicle is achieved by employing V-shaped cuts in the covering material. Tubular attachments to the cover are utilized to hold the cover in place and the rear-most tube is located in the trunk of the vehicle in order to fix the cover in place, requiring the user to open and close the vehicle trunk each time the cover is used.

There are a number of commercial car cover products presently available For example, car covers are made and/or distributed by Car Covers Direct or Car Cover World. The covers offered for sale by the foregoing are large sheets having a size to fit a particular vehicle or class of vehicles and are attached to the vehicle by an elastic material that is located around the periphery of the cover and that fits under the vehicle body. None of these products has any provision to aid in the deployment of the car cover. The fact that deployment and removal of a car cover is inconvenient is reflected in the two products, CoolCar™ car cover and Roll up™ car cover. The CoolCar™ car cover uses padded weights around the edge of the cover to help facilitate throwing the car over the top of the vehicle. The CoolCar™ car cover can be held firmly in place by closing the doors on the cover, thereby trapping a portion of the reflective material inside the car where heat can be partially trapped, as well as causing additional wear and tear on the cover itself. For the Roll up™ car cover an electric windup device is used to roll the car cover inside a drum. While the approach utilized by the Roll up™ provides convenient storage for the car cover and should be effective in helping remove the car cover, it is not obvious that deployment of the car cover is facilitated thereby.

In view of the foregoing disadvantages associated with the prior art car covers, it has become desirable to develop a car cover that can be readily deployable on and removable from a vehicle and which can be readily stored in a compact configuration when not in use.

### SUMMARY OF THE INVENTION

The present invention solves the problems associated with the prior art car covers and other problems by providing a car cover that has a number of small weights or magnets attached to the periphery thereof to hold the cover in place when deployed, either by the force exerted by the weights or by magnetic attraction to the vehicle body if the body is comprised of a metal having a magnetic permeability, as is typical of steel alloys. The car cover has several panels on its underside that can be inserted into the vehicle doors before they are closed or into the vehicle trunk before it is closed, thereby providing additional mechanical stability against wind or theft. Additional side attachments that may be fixed to external rear-view mirrors may also be used for additional mechanical stability. When the car cover is fully deployed it will cover the front, back and all side windows as well as the vehicle top and all or part of the front (hood) and back (trunk) sections of the vehicle body. A deployment rod is provided to assist in the deployment and subsequent removal of the car cover from the vehicle and to provide a means for storing the car cover when not in use.

An object of the present invention to provide a car cover assembly that can be deployed or removed quickly by one person and stored conveniently in any storage area available in the vehicle.

Another object of the present invention is to provide a deployment device to hold any flexible material that can be folded to minimize the storage space required, with or without the flexible material in place.

A still another object of the present invention is to provide a car cover that allows all windows to be covered and which is held in place by a combination of weights or magnets around the periphery of the cover and includes provision for being held in place by the doors and the truck of the vehicle, to accomplish stability against the wind and to discourage theft.

A further object of the present invention is to provide a car cover that minimizes the buildup of interior heating within a vehicle that is parked in the sun, to protect the vehicle against the elements, such as interior or exterior damage from natural or artificial light, sap or other secretions from trees or other plans, bird or other animal droppings that might occur when the vehicle is parked under trees or other areas where birds or animals may inhabit, and to protect the vehicle from natural or unnatural damaging liquids, such as sea spray, paint spray, and chemicals that may be present in the surrounding environment etc.

### BRIEF DESCRIPTION OF THE DRAWINGS

FIG. 1 is a bottom plan view of the car cover of the present invention.

FIG. 2 is a top and/or bottom plan view of the deployment rod of the present invention and illustrates the deployment rod in the extended orientation and with the support rod therein in the engaged and disengaged condition.

FIG. 3 is a top and/or bottom plan view illustrating the deployment rod of the present invention in the folded condition.

FIG. 4 is a top plan view of an alternate embodiment of the car cover of the present invention.

FIG. 5 is a top and/or bottom plan view of an alternate embodiment of the deployment rod of the present invention and illustrates the deployment rod in both the extended orientation and in the folded orientation.

FIG. 6 is a top and/or bottom plan view of another alternate embodiment of the deployment rod of the present invention and illustrates the deployment rod in both the extended orientation and in the folded orientation.

### DESCRIPTION OF THE PREFERRED EMBODIMENT

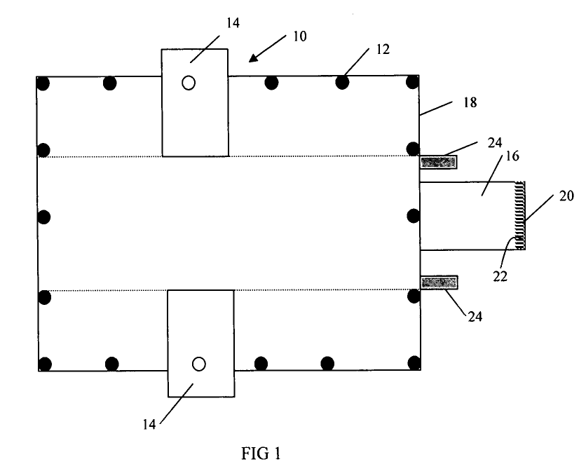

Referring now to the Figures where the illustrations are for the purpose of describing the preferred embodiment of the present invention and are not intended to limit the invention described herein, FIG. 1 is a bottom plan view of the car cover 10 of the present invention. The car cover 10 can be formed from a single sheet of flexible material, such as Tyvek® distributed by the Dupont Corporation or NOAH® and BLOCK IT® Evolution, both distributed by the Kimberly-Clark Corporation. Small magnets or weights 12 are attached to the periphery of the car cover 10 to facilitate deployment and to hold the car cover 10 in place after deployment over the vehicle being covered. Two oppositely directed panels 14 of flexible material are attached to the underside of the car cover 10. Panels 14 are held in place by the closed driver-side and passenger-side doors of the vehicle for increased stability. An additional panel 16 is attached to the end 18 of the car cover 10 permitting a portion of the panel 16 to be closed inside the trunk of the vehicle for the same purpose. A plastic tube or the like 20 can be attached to the end 22 of panel 16 to provide a hand-hold and to facilitate placing the end 22 of the panel 16 in the trunk of the vehicle. The use of panels 14, 16 is discretionary as they provide stability and security in addition to that provided by the magnets or weights 12. Two fasteners 24, such as hook-and-eye type fasteners commonly known as Velcro® fasteners, snap-type fasteners, clip-type fasteners, clasp-type fasteners, or the like, are attached in a spaced-apart relationship to the end 18 of the car cover 10 for attachment to a deployment rod, herein after described.

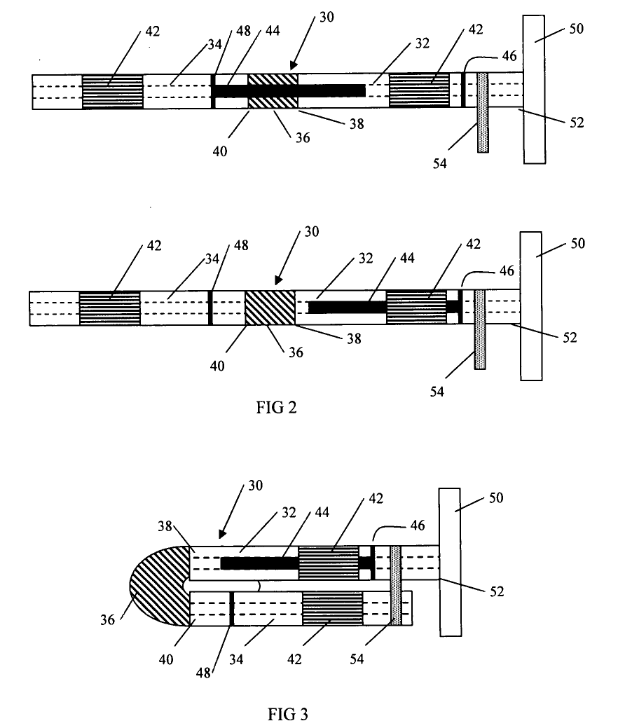

Referring now to FIG. 2, a top and/or bottom plan view of a deployment rod 30 in the fully extended position is illustrated. The deployment rod 30 can be constructed of any suitable light weight hollow plastic or metallic material and is comprised of a first longitudinally extending portion 32 and a second longitudinally extending portion 34. A flexible joining member 36 connects end 38 of first longitudinally extending portion 32 with end 40 of second longitudinally extending portion 34. Complementary fasteners 42 are positioned in a spaced-apart relationship on first and second longitudinally extending portions 32, 34 so as to be aligned with and engageable with fasteners 24 on end 18 of car cover 10 permitting the end 18 of the car cover 10 to be attached and detached from the deployment rod 30. A support rod 44 is slidingly movable within first, longitudinally extending portion 32, joining member 36 and second longitudinally extending portion 34 minimizing bending of the deployment rod 30 about joining member 36 when the deployment rod 30 is in the fully extended position. The support rod 44 stiffens the deployment rod 30 facilitating the deployment or removal of the car cover 10 on a vehicle. Stop members 46, 48 are provided in first longitudinally extending portion 32 and second longitudinally portion 34, respectively, to limit the lateral movement of support rod 44 therein. A cross-member 50 is attached to end 52 of first longitudinally extending portion 32 of deployment rod 30 and acts as a handle for the deployment rod 30 and assists in rolling the car cover 10 onto a vehicle or removing the car cover 10 from the vehicle. An elastic cord 54 is attached to first longitudinally extending portion 32 adjacent cross-member 50 and is utilized to retain the deployment rod 30 in the non-extended (folded) orientation, as hereinafter described. The flexible joining member 36 that interconnects the first and second longitudinally extending portions 32, 34 of the deployment rod 30 permits the deployment rod 30 to be folded with or without the car cover 10 thereon for storage purposes.

In the preferred embodiment of the present invention, the deployment rod 30 with the car cover 10 rolled thereon is placed at the front of the vehicle to be covered. Assuming that the cross-member 50 attached to the deployment rod 30 is on the driver's side of the car and that oppositely disposed panels 14 are in the downwardly directed position when the car cover 10 was rolled up onto the deployment rod 30, then the panels 14 will also be on the underside of the deployed car cover 10. The magnets or weights 12 hold the car cover 10 in place as it is being unrolled from the deployment rod 30 in the direction of the rear of the vehicle. When the car cover 10 is fully deployed on the vehicle, the deployment rod 30 is resting on the vehicle trunk area or hanging loosely in the case of a vehicle without a trunk (e.g., a van or hatchback vehicle) and the front and rear windows of the vehicle are completely covered. The deployment rod 30 is removed from the fasteners 24 on end 18 of cover 10, and the deployment rod 30 can be folded about joining member 36 for storage purposes. Then, at the user's discretion, the panels 14 can be inserted into the vehicle by closing the driver side and passenger side doors on them and panel 16 can be inserted into the trunk area in a similar manner. The remaining portion of the car cover 10 can then be unfolded from the roof of the vehicle in order to cover the side windows of the vehicle. The width of the cover 10 is sufficient so that the magnets or weights 12 hang below the windows and assist in holding the cover 10 in position so as to cover all side windows. Thus, all windows are covered and depending on the size of the cover 10, much of the vehicle hood and trunk exterior surface is similarly covered.

Removal of the car cover 10 from the vehicle follows a similar procedure. The deployment rod 30 is oriented in the open position and is attached by the fasteners 42 thereon to the fasteners 24 on end 18 of car cover 10 and is oriented so that cross-member 50 of the deployment rod 30 is on the driver's side of the vehicle. The panels 14 and 16 are removed from the front doors and trunk, respectively. The portion of the car cover 10 hanging over the side windows of the vehicle is folded on top of the vehicle, with the magnets or weights 12 holding the cover loosely in place. Starting from the rear of the vehicle and using the cross-member 50 of the deployment rod 30 to facilitate rotation of the deployment rod 30, the car cover 10 is rolled onto the deployment rod 30 while the user walks toward the front of the vehicle. After the car cover 10 is completely rolled onto the deployment rod 30, the deployment rod 30 is folded onto itself about flexible joint 36, and the deployment rod 30 with the cover 10 wound thereon can be stored within the vehicle or vehicle trunk.

FIG. 3 shows the deployment rod 30 configured for folding and storage with or without the car cover 10 rolled thereon. In going from the open (fully extended) orientation as illustrated in FIG. 2 to the closed and folded orientation shown in FIG. 3, the user would slide the support rod 44 into the first longitudinally extending portion 32 of the deployment rod 30. The deployment rod 30 can then be folded about flexible joint member 36 and retained in the closed position by elastic cord 54. To go from the closed and folded orientation to the open (fully extended) orientation, the user releases the elastic cord 54, straightens the deployment rod 30 and moves the support rod 44 so as to be positioned within the first longitudinally extending portion 32, the joining member 36 and the second longitudinally extending portion 34 stiffening the deployment rod 30 facilitating the deployment or removal of the car cover 10 from a vehicle.

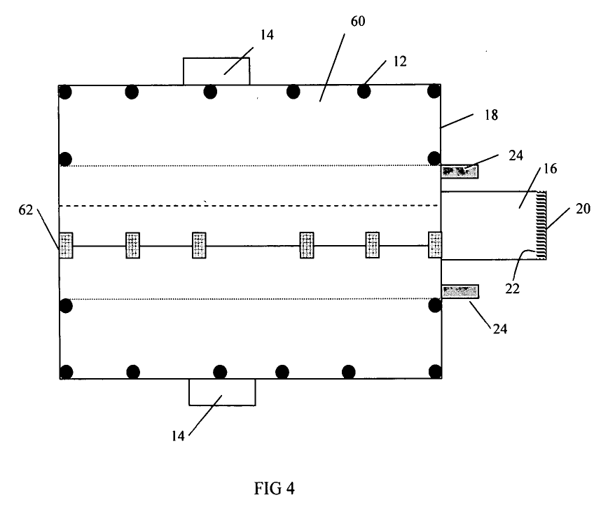

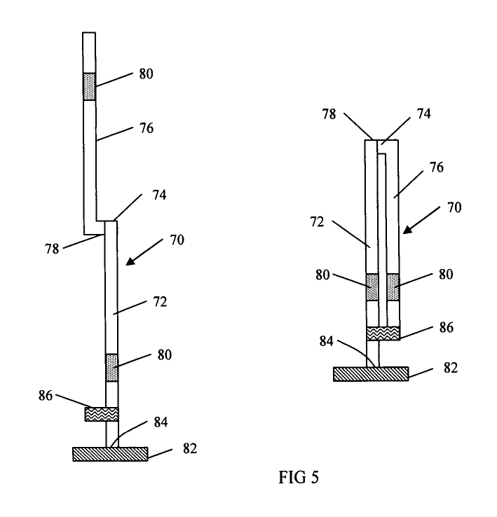

FIG. 4 shows an alternate embodiment of the car cover of the present invention to be used in the event that the car cover material is insufficiently flexible to accommodate the folding required for the closed and folded (storage) position. In this case the car cover is composed of two overlapping sheets 60 of material, joined by strips 62 of suitable flexible material at the front, back and several intermediate positions along their length. The fold will occur at the point of the sheet overlap, such that there will be sufficient flexibility for the folding to be accomplished in a convenient manner.

FIG. 5 is an alternate design for the deployment rod 70 illustrated in both the extended and folded orientation. In this embodiment, the first longitudinally extending portion 72 has a yoke 74 at its distal end into which the second longitudinally extending portion 76 is received and attached thereto by a rotating joint member 78. The yoke 74 and flexible joint member 78 are sized such that there is a reasonably tight friction fit between the first and second longitudinally extending portions 72, 76 so as to impart mechanical rigidity to the deployment rod 70 when in the extended orientation, but not so much friction as to prevent the first and second longitudinally extending portions 72, 76 from being folded about rotating joint member 78 so as to be adjacent to one another. The second longitudinally extending portion 76 has an elongated L-configuration, such that there is sufficient room to accommodate the car cover 10 when it is folded between the first and second longitudinally extending portions 72, 76. The deployment rod 70 has complementary fasteners 80 in a spaced-apart relationship on the periphery thereof allowing the rod 70 to be attached to end 18 of cover 10. A cross-member 82 is attached to end 84 of first longitudinally extending portion 72 of deployment rod 70 and acts as a handle for the deployment rod 70 and assists in rolling the car cover onto a vehicle or removing the car cover from the vehicle. An elastic cord 86 is attached to first longitudinally extending portion 72 adjacent cross-member 82 and is utilized to retain the deployment rod 70 in the non-extended (folded) orientation.

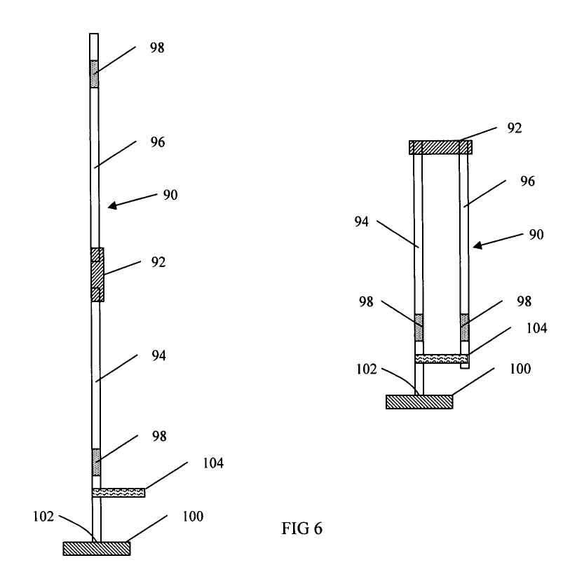

FIG. 6 is another alternate design for the deployment rod 90 illustrated in both the extended and folded orientation. In this embodiment, the flexible joint member 92 is a yoke that accommodates both the first longitudinally extending portion 94 and the second longitudinally extending portion 96 of rod 90. The yoke is sized such that there is a reasonably tight friction fit between the joint member 92 and the first longitudinally extending portion 94 and the second longitudinally extending portion 96 so as to impart mechanical rigidity to the rod 90 when the rod 90 is fully extended but not so much friction so as to prevent the first longitudinally extending portion 94 and the second longitudinally extending portion 96 from being folded onto one another when the rod 90 is in the folded orientation. The joint member 92 is sized such that there is sufficient room to accommodate the car cover 10 when the cover 10 is folded between the first and second longitudinally extending portions 94, 96. The rod 90 has complementary fasteners 98 in a spaced-apart relationship attached to the periphery thereof allowing the rod 90 to be attached to end 18 of cover 10. As in the previous embodiments, a cross-member 100 is attached to end 102 of first longitudinally extending portion 94 of deployment rod 90 and acts as a handle for the deployment rod 90 and assists in rolling the car cover onto a vehicle or removing the car cover from the vehicle. An elastic cord 104 is attached to first longitudinally extending portion 94 adjacent cross-member 100 and is utilized to retain the deployment rod 90 in the non-extended (folded) orientation.

Certain modifications and improvements will occur to those skilled in the art upon reading the foregoing. It is understood that all such modifications and improvements have been deleted herein for the sake conciseness and readability, but are properly within the scope of the following claims.

I claim:

1. A car cover comprising an elongated sheet of flexible material of sufficient size to cover at least a portion of a vehicle, a plurality of weight devices attached to said elongated sheet of flexible material around at least a portion of the periphery thereof, and at least one fastening device attached to said periphery of said elongated sheet of flexible material.

2. The car cover as defined in claim 1 wherein said plurality of weight devices are made from non-metallic material.

3. The car cover as defined in claim 1 wherein said plurality of weight devices are made from metallic material.

4. The car cover as defined in claim 1 wherein said at least one fastening device comprises a pair of fasteners positioned in a spaced-apart relationship.

5. The car cover as defined in claim 1 further including oppositely disposed panels of material attached to said elongated sheet of flexible material, said oppositely disposed panels of material being oriented in a substantially transverse relationship with respect to the longitudinal axis of said elongated sheet of flexible material.

6. The car cover as defined in claim 1 further including a panel of material attached to said periphery of said elongated sheet of flexible material, the longitudinal axis of said panel of material being substantially parallel to the longitudinal axis of said elongated sheet of flexible material.

7. The car cover as defined in claim 4 further including a panel of material attached to said periphery of said elongated sheet of material and interposed between said pair of fasteners.

8. A car cover and a deployment device therefore, in combination, comprising an elongated sheet of flexible material of sufficient size so as to cover at least a portion of a vehicle, a plurality of weight devices attached to said elongated sheet of flexible material around at least a portion of the periphery thereof, at least one fastening device attached to said periphery of said elongated sheet of flexible material and a deployment rod having at least one fastening device attached to the periphery thereof.

9. The combination as defined in claim 8 wherein said plurality of weight devices are made from non-metallic material.

10. The combination as defined in claim 8 wherein said plurality of weight devices are made from metallic material.

11. The combination as defined in claim 8 wherein said at least one fastening device attached to said periphery of said elongated sheet of flexible material comprises a pair of fasteners in a spaced-apart relationship and said at least one fastening device attached to said periphery of said deployment rod comprises a pair of fasteners in a spaced-apart relationship, the transverse distance between said pair of fasteners attached to said periphery of said elongated sheet of flexible material approximating the transverse distance between said pair of fasteners attached to said periphery of said deployment rod.

12. The combination as defined in claim 8 further including oppositely disposed panels of material attached to said elongated sheet of flexible material, said oppositely disposed panels of material being oriented in a substantially transverse relationship with respect to the longitudinal axis of said elongated sheet of flexible material.

13. The combination as defined in claim 8 further including a panel of material attached to said periphery of said elongated sheet of flexible material, the longitudinal axis of said panel of material being substantially parallel to the longitudinal axis of said elongated sheet of flexible material.

14. The combination as defined in claim 11 further including a panel of material attached to said periphery of said elongated sheet of flexible material and interposed between said pair of fasteners attached to said elongated sheet of flexible material.

15. The combination as defined in claim 8 wherein said deployment rod is comprised of a first longitudinally extending member, a second longitudinally extending member and a joining member interconnecting said first longitudinally extending member and said second longitudinally extending member.

16. The combination as defined in claim 15 wherein said first longitudinally extending member has a first end and an oppositely disposed second end, and said second longitudinally extending member has a first end and an oppositely disposed second end, said second end of said first longitudinally extending member being operatively connected to said first end of said second longitudinally extending member by said joining member.

17. The combination as defined in claim 16 further including a cross-member attached to said first end of said first longitudinally extending member, said cross-member acting as a handle to assist in the turning of said deployment rod.
